(19) United States
(12) Patent Application Publication
(10) Pub. No.: US 2009/0175470 A1
(43) Pub. Date: Jul. 9, 2009

(54) ACOUSTIC WAVE DEVICE AND METHOD OF MANUFACTURING THE SAME

(75) Inventors: Shunichi Aikawa, Yokohama (JP); Masayuki Kitajima, Yokohama (JP); Keiji Tsuda, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU MEDIA DEVICES LIMITED, Yokohama-shi (JP)

(21) Appl. No.: 12/349,265

(22) Filed: Jan. 6, 2009

(30) Foreign Application Priority Data
Jan. 7, 2008 (JP) 2008-000539

(51) Int. Cl. H04R 25/00; H04R 31/00

(52) U.S. Cl. 381/190; 29/594

(57) ABSTRACT

An acoustic wave device includes a substrate; an acoustic wave element provided on the substrate; a terminal that is provided on the substrate and is electrically coupled to the acoustic wave element; a first insulating layer that is provided on the substrate and has a first opening at a region thereof overlapped with at least a part of the terminal; a second insulating layer that has an second opening at a region thereof overlapped with at least a part of the first opening and is provided on the first insulating layer and the acoustic wave element so that a cavity is formed above the acoustic wave element; a third insulating layer that has a third opening including the region where the first opening and the second opening are overlapped with each other, and is provided on the second insulating layer; a metal post that is electrically coupled to the terminal and is provided in the first opening, the second opening and the third opening; and a solder ball provided on the metal post.

### CROSS-REFERENCE TO RELATED APPLICATION

This application is based upon and claims the benefit of priority of the prior Japanese Patent Application No. 2008-000539, filed on Jan. 7, 2008, the entire contents of which are incorporated herein by reference.

### FIELD

The present invention generally relates to an acoustic wave device and a method of manufacturing the acoustic wave device, and more particularly, to an acoustic wave device having a insulating layer and a method of manufacturing the acoustic wave device.

### BACKGROUND

An acoustic wave device having an acoustic wave element on a substrate is being used widely as a duplexer or a filter of a mobile communication device.

There is a surface acoustic wave device using an acoustic wave and having a surface acoustic wave element as an acoustic wave element. The surface acoustic wave element has an IDT (Interdigital Transducer) formed on a surface of a piezoelectric substrate and has a reflector. The surface acoustic wave device uses an acoustic wave excited with electrical power provided to the surface acoustic wave element. The surface acoustic wave device is being widely used for a circuit treating a radio signal in a frequency range from 45 MHz to 2 GHz, such as a band pass filter for transmission, a band pass filter for reception or an antenna duplexer.

Recently, there is developed an acoustic wave device using a piezoelectric thin film resonator (FBAR: Film Bulk Acoustic Resonator) acting as an acoustic wave element in which a pair of electrodes are formed on both faces of a piezoelectric thin film and a thickness vibration of the piezoelectric thin film is used. The acoustic wave device using the FBAR has a high property specifically in a high frequency wave range. Therefore, the acoustic wave device is used in a frequency range from 1 GHz to 10 GHz or the like.

It is necessary to form a cavity above the acoustic wave element in which the acoustic wave element vibrates, if the surface acoustic wave element or the FBAR is used.

Recently, there is a demand for downsizing the acoustic wave device with a development of mobile communication field. There is developed a WLCSP (Wafer Level Chip Size Package) technology in which package size of a device is downsized to that of an acoustic wave element, as a technology satisfying the demand.

Japanese Patent Application Publication No. 2006-352430 (hereinafter referred to as Document 1) discloses an art where an insulating layer is provided so that a cavity is formed around an acoustic wave element provided on a piezoelectric substrate, and a solder ball is formed to be connected to a terminal via an opening of the insulating layer.

However, the acoustic wave device disclosed in Document 1 does not have high mass productivity in manufacturing process and an equipment for manufacturing, although the acoustic wave device may be downsized.

### SUMMARY

The present invention has been made in view of the above circumstances and provides an acoustic wave device that may be downsized and has high mass productivity, and a method of manufacturing the acoustic wave device.

According to an aspect of the present invention, there is provided an acoustic wave device including a substrate; an acoustic wave element provided on the substrate; a terminal that is provided on the substrate and is electrically coupled to the acoustic wave element; a first insulating layer that is provided on the substrate and has a first opening at a region thereof overlapped with at least a part of the terminal; a second insulating layer that has an second opening at a region thereof overlapped with at least a part of the first opening and is provided on the first insulating layer and the acoustic wave element so that a cavity is formed above the acoustic wave element; a third insulating layer that has a third opening including the region where the first opening and the second opening are overlapped with each other, and is provided on the second insulating layer; a metal post that is electrically coupled to the terminal and is provided in the first opening, the second opening and the third opening; and a solder ball provided on the metal post. With the structure, diameter of the solder ball is not limited by installation region of the cavity and the acoustic wave element. It is therefore possible to downsize the acoustic wave device. And it is possible to improve mass productivity because a control of a shape of the metal post tends to be easier.

According to another aspect of the present invention, there is provided a method of manufacturing an acoustic wave device including: providing an acoustic wave element on a substrate; providing a terminal on the substrate so as to be electrically coupled to the acoustic wave element; providing a first insulating layer on the substrate so that the acoustic wave element is exposed and a first opening of the first insulating layer is overlapped with at least a part of the terminal; providing a second insulating layer on the substrate and the first insulating layer so that a cavity is formed above the acoustic wave element and a second opening of the second insulating layer is overlapped with at least a part of the first opening; providing a third insulating layer on the second insulating layer so that a third opening of the third insulating layer includes the region where the first opening and the second opening are overlapped with each other.; providing a metal post in the first opening, the second opening and the third opening so as to be electrically coupled to the terminal; and providing a solder ball on the metal post. With the method, diameter of the solder ball is not limited by installation region of the cavity and the acoustic wave element. It is therefore possible to downsize the acoustic wave device. And it is possible to improve mass productivity because a control of a shape of the metal post tends to be easier.

### BRIEF DESCRIPTION OF THE DRAWINGS

FIG. 1 illustrates a cross sectional view of a surface acoustic wave device in accordance with a first comparative embodiment;

FIG. 2A through FIG. 2D illustrate a cross sectional view showing a method of manufacturing the surface acoustic wave device in accordance with the first comparative embodiment;

FIG. 3A through FIG. 3D illustrate a cross sectional view showing the method of manufacturing the surface acoustic wave device in accordance with the first comparative embodiment;

FIG. 4A and FIG. 4B illustrate a variation of the first comparative embodiment;

FIG. 5 illustrates a cross sectional view of a piezoelectric device in accordance with a second comparative embodiment;

FIG. 6 illustrates a cross sectional view of a surface acoustic wave device in accordance with a first embodiment;

FIG. 7A through FIG. 7D illustrate a cross sectional view showing a method of manufacturing the surface acoustic wave device in accordance with the first embodiment;

FIG. 8A illustrates a top view of the surface acoustic wave device in accordance with the first embodiment;

FIG. 8B illustrates a cross sectional view taken along a line A-A1; and

FIG. 9 illustrates a cross sectional view of a surface acoustic wave device in accordance with a variation of the first embodiment.

### DESCRIPTION OF EMBODIMENTS

A description will be given of a problem the present invention solves, with reference to drawings.

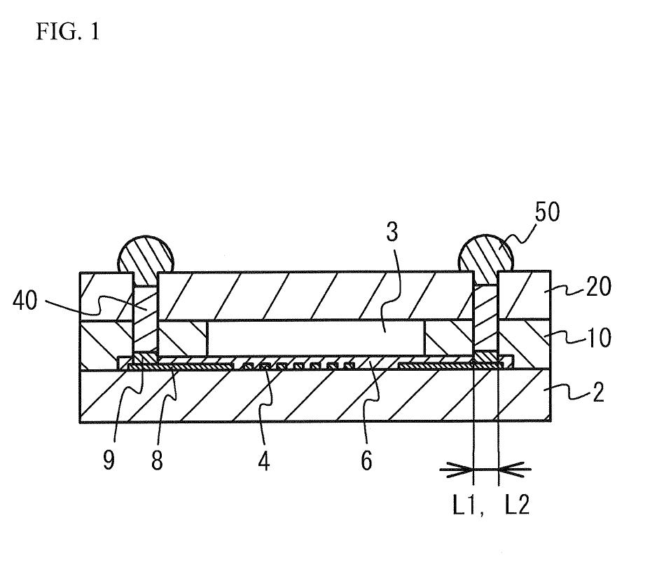

FIG. 1 illustrates a cross sectional view of a surface acoustic wave device in accordance with a first comparative embodiment. A surface acoustic wave element 4 and an interconnection 8 are provided on a piezoelectric substrate 2. The piezoelectric substrate 2 is made of such as LiTaO₃ (lithium tantalate) or LiNbO₃ (lithium niobate). The surface acoustic wave element 4 has an IDT formed with Al—Cu (aluminum-copper) and a reflector, and acts as an acoustic wave element. The interconnection 8 is electrically coupled to the surface acoustic wave element 4. A part of the surface acoustic wave element 4 and a part of the interconnection 8 are covered with a protective layer 6 made of silicon compound such as SiO₂ (silicon dioxide) or SiN (silicon nitride). A terminal 9 is provided on a region of the interconnection 8 not covered with the protective layer 6. The region is electrically coupled to the surface acoustic wave element 4 via the interconnection 8. A first insulating layer 10 having thickness of 30 μm is provided on the piezoelectric substrate 2 and the protective layer 6 not to overlap with the surface acoustic wave element 4. The first insulating layer 10 has a first opening 12 at a region where the first insulating layer 10 is overlapped with the terminal 9. A second insulating layer 20 having thickness of 30 μm is provided on the first insulating layer 10 and the protective layer 6 so that a cavity 3 is formed above the surface acoustic wave element 4. The second insulating layer 20 has a second opening 22 at a region where the second insulating layer 20 is overlapped with the first opening 12. A diameter of the terminal 9, an opening length L1 of the first opening 12 and an opening length L2 of the second opening 22 are therefore equal to each other. The first insulating layer 10 and the second insulating layer 20 are made of a photosensitive resin such as epoxy-based negative resist. A metal post 40 electrically coupled to the terminal 9 is provided in the first opening 12 and the second opening 22. A solder ball 50 is provided on the metal post 40. The solder ball 50 acts as a connection terminal between the surface acoustic wave device and an outer component.

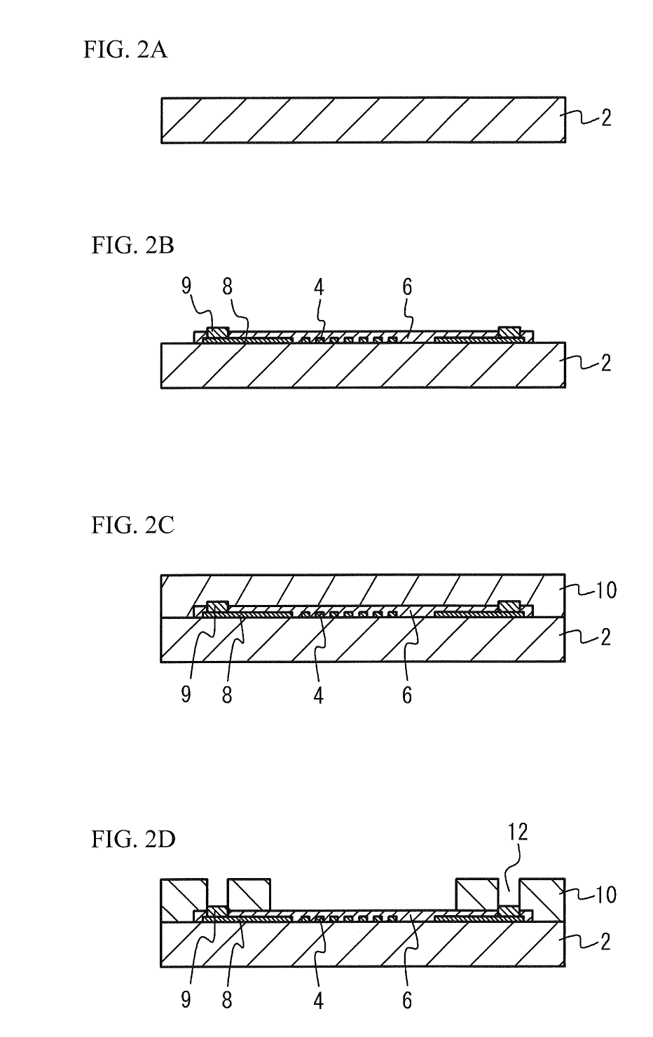

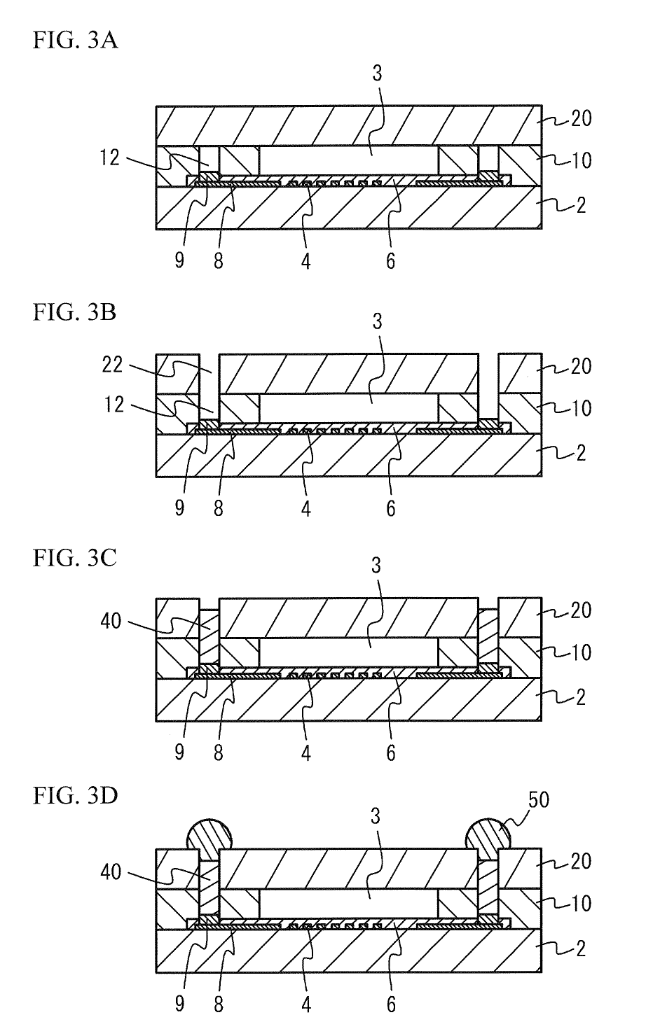

A description will be given of a method of manufacturing the surface acoustic wave device in accordance with the first comparative embodiment, with reference to FIG. 2A through FIG. 3D.

FIG. 2A illustrates a cross sectional view of the piezoelectric substrate 2. FIG. 2B illustrates a cross sectional view of the structure in which the surface acoustic wave element 4, the interconnection 8, the protective layer 6 and the terminal 9 are provided on the piezoelectric substrate 2.

FIG. 2C illustrates a cross sectional view showing a process of forming the first insulating layer 10 on the piezoelectric substrate 2. As illustrated in FIG. 2C, epoxy-based negative resist is coated on the piezoelectric substrate 2 with a spin coating method, and the first insulating layer 10 is formed. FIG. 2D illustrates a cross sectional view showing a photolithography. A region of the first insulating layer 10 overlapped with the surface acoustic wave element 4 is removed with the lithography. A region where the first insulating layer 10 is overlapped with the terminal 9 is removed. Thus, the first opening 12 is formed.

FIG. 3A illustrates a cross sectional view showing a process of forming the second insulating layer 20. The second insulating layer 20 is formed when a film-shaped epoxy-based negative resist having thickness of 30 μm is adhered on the protective layer 6, the terminal 9 and the first insulating layer 10, with a tenting method. FIG. 3B illustrates a cross sectional view showing a process of forming the second opening 22. A region of the second insulating layer 20 overlapped with the first opening 12 is removed with the lithography. Thus, the second opening 22 is formed. The cavity 3 surrounded with the first insulating layer 10 and the second insulating layer 20 is formed above the surface acoustic wave element 4.

FIG. 3C illustrates a cross sectional view showing a process of forming the metal post 40. The metal post 40 is formed in the first opening 12 and the second opening 22, when a metal is grown from the terminal 9 to the second opening 22 with an electrolytic plating method. FIG. 3D illustrates a cross sectional view showing a process of forming the solder ball 50. The solder ball 50 is formed when a solder made of SnAgCu is printed on the metal post 40 and is subjected to a reflow. With the processes, the surface acoustic wave device in accordance with the first comparative embodiment is fabricated.

As illustrated in FIG. 1, the diameter of the terminal 9, the opening length L1 of the first opening 12 and the opening length L2 of the second opening 22 are reduced when the surface acoustic wave device is downsized. The connection to the outer component may be degraded when the diameter of the solder ball 50 is reduced. It is necessary to keep the diameter of the solder ball 50 large in order to make a preferable connection. It is only necessary to enlarge the opening length L2 in order to provide the solder ball 50 having a large diameter easily. The opening length L1 of the first opening 12 and the opening length L2 of the second opening 22 are limited, because the surface acoustic wave device in accordance with the first comparative embodiment has the surface acoustic wave element 4. This results in an obstacle against downsizing of the surface acoustic wave device with the diameter of the solder ball 50 being kept large. A description will be given of this, with reference to a variation of the first comparative embodiment.

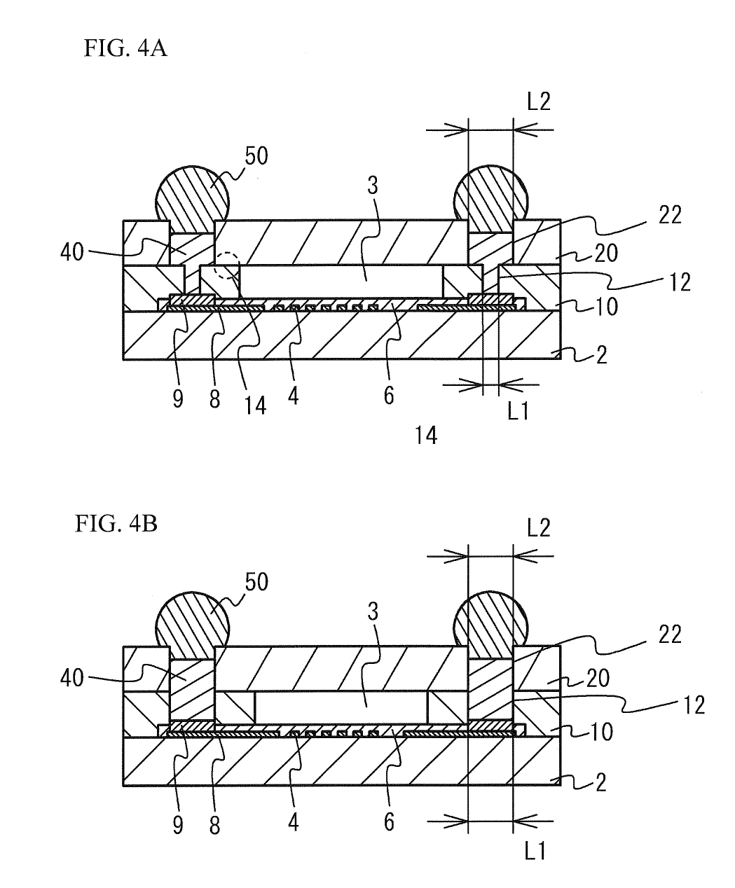

FIG. 4A illustrates a cross sectional view of a first variation of the first comparative embodiment. As illustrated in FIG. 4A, the first variation is an example in which the opening length L2 of the second opening 22 is larger than the opening length L1 of the first opening 12, and the surface acoustic wave device is downsized. In this case, it is necessary to form the cavity 3 above the surface acoustic wave element 4. Therefore, a connection portion 14 between the first insulating layer 10 and the second insulating layer 20 must be left. This results in a limitation of the opening length L2 of the second opening 22. It is therefore difficult to downsize the surface acoustic wave device, with the diameter of the solder ball 50 being kept large.

FIG. 4B illustrates a cross sectional view of a second variation of the first comparative embodiment. As illustrated in FIG. 4B, the second variation is an example in which the opening length L1 of the first opening 12 is equal to the opening length L2 of the second opening 22, both of the length are enlarged, and the surface acoustic wave device is downsized. In this case, the opening length L1 of the first opening 12 is limited to outside of the location of the surface acoustic wave element 4, because the surface acoustic wave element 4 is provided between the two first openings 12. It is therefore difficult to downsize the surface acoustic wave device with the diameter of the solder ball 50 being kept large.

A description will be given of the surface acoustic wave device disclosed in Document 1, as a second comparative embodiment.

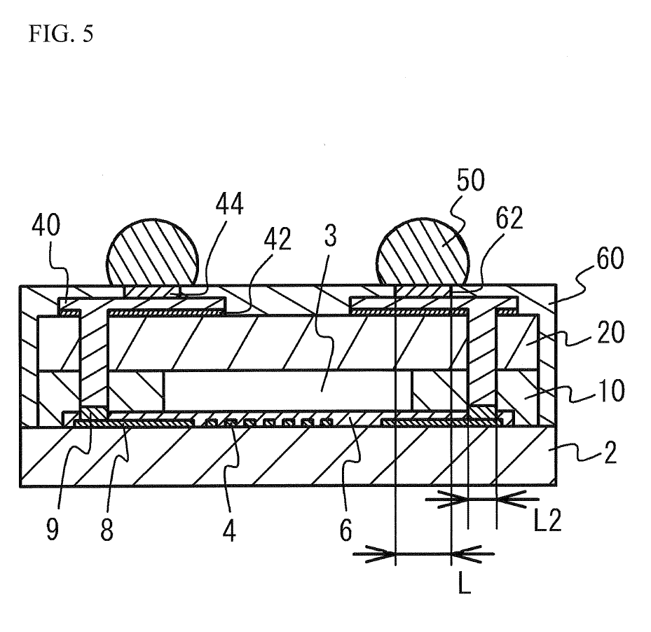

FIG. 5 illustrates a cross sectional view of the surface acoustic wave device in accordance with the second comparative embodiment. As illustrated in FIG. 5, a metal layer 42 is provided on the second insulating layer 20. The metal post 40 is formed from on the terminal 9 to on the metal layer 42. An external resin 60 is provided on the piezoelectric substrate 2 so as to house the first insulating layer 10, the second insulating layer 20, the metal layer 42 and the metal post 40. The external resin 60 has an opening 62 at a region where the metal post 40 is overlapped. An under bump metal 44 is filled in the opening 62. The solder ball 50 is provided on the under bump metal 44.

In accordance with the second comparative embodiment, it is possible to arrange the solder ball 50 at optional position and change the diameter of the solder ball 50, when the position of the opening 62 and the opening length L of the opening 62 are changed. It is difficult to control the shape of the metal post 40, because there is no mask for defining the shape of the metal post 40 on the second insulating layer 20 in a plating process for forming the metal post 40. The cavity 3 may be formed with photolithography method because the first insulating layer 10 is made of photosensitive resin. In contrast, the second opening 22 is formed with a laser process or a dry etching process, because the second insulating layer 20 is made of non-photosensitive resin. Therefore, equipment for the photolithography, the laser process or the dry etching process is needed. The surface acoustic wave device is not superior in mass productivity in aspects of process and equipment.

A description will be given of an embodiment for solving the above-mentioned problem with reference to drawings.

### First Embodiment

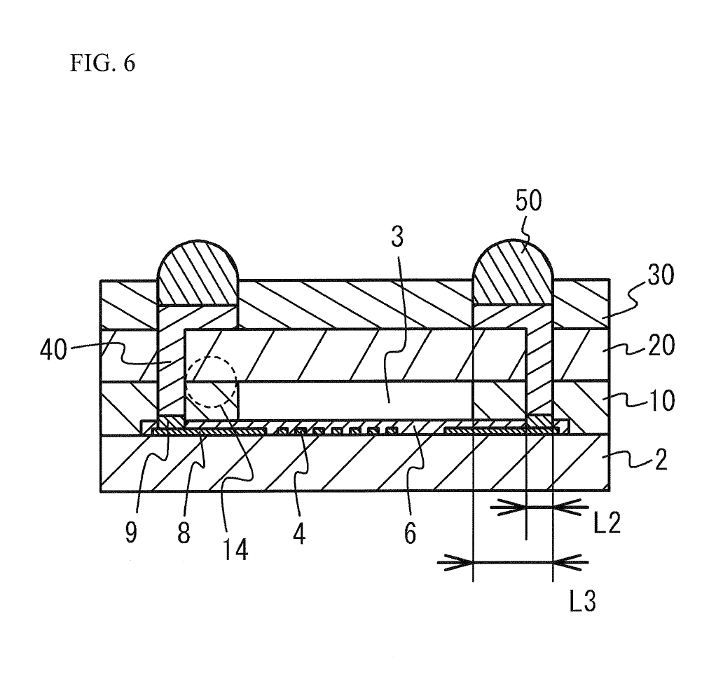

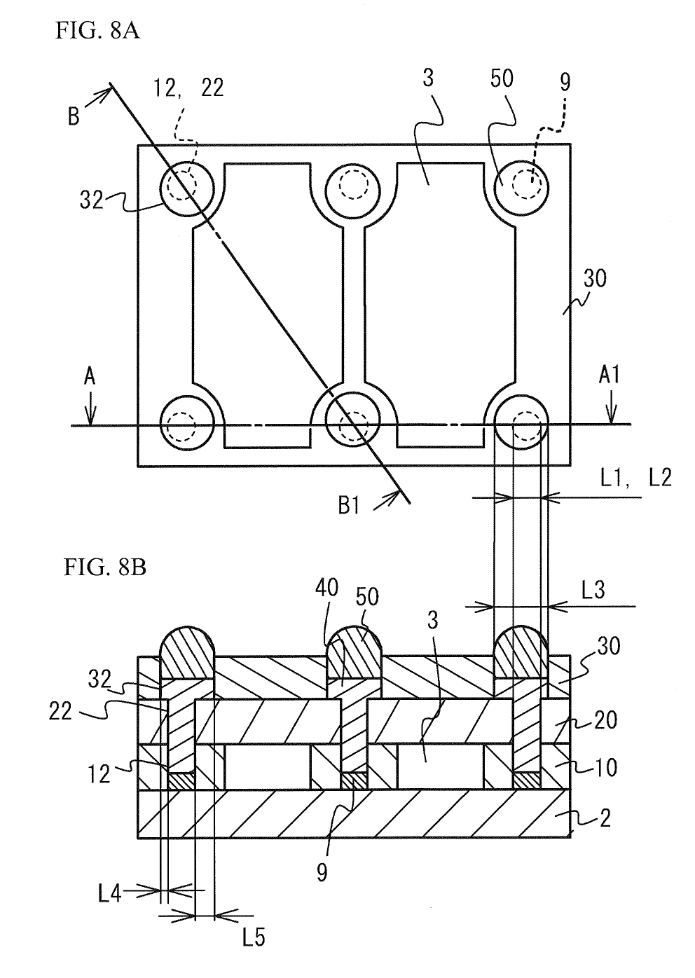

FIG. 6 illustrates a cross sectional view of a surface acoustic wave device in accordance with a first embodiment, and a cross sectional view taken along a line B-B1 of FIG. 8A described later. As illustrated in FIG. 6, a third insulating layer 30 is provided on the second insulating layer 20. The third insulating layer 30 is made of photosensitive resin such as epoxy-based negative resist and has thickness of 30 μm. The third insulating layer 30 has a third opening 32 having an opening length L3 at a region where the first opening 12 and the second opening 22 are overlapped with each other. The metal post 40 is provided in the first opening 12, the second opening 22 and the third opening 32. Height of the metal post 40 from the piezoelectric substrate 2 to the upper face of the metal post 40 is lower than a height from the piezoelectric substrate 2 to the upper face of the third insulating layer 30. The solder ball 50 is provided on the metal post 40. A part of the solder ball 50 is implanted in the third opening 32.

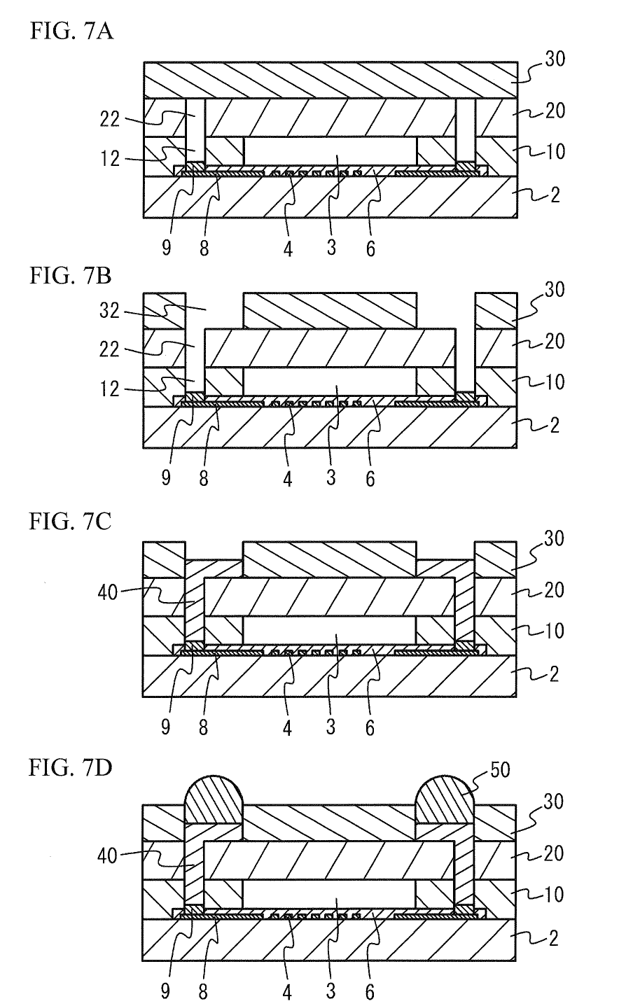

Next, a description will be given of a method of manufacturing the surface acoustic wave device in accordance with the first embodiment. FIG. 7A through FIG. 7D illustrate a cross sectional view showing the manufacturing process of the surface acoustic wave device in accordance with the first embodiment. The process until the second opening 22 is formed is the same as that of the first comparative embodiment (with reference to FIG. 2A through FIG. 3B), and is omitted.

FIG. 7A illustrates a cross sectional view showing a process of forming the third insulating layer 30. A photosensitive resin such as film-shaped epoxy-based negative resist is adhered to the second insulating layer 20 with a tenting method. This results in a formation of the third insulating layer 30.

FIG. 7B illustrates a cross sectional view showing a process of forming the third opening 32. The third opening 32 is formed in the third insulating layer 30 with the photolithography method. The third opening 32 includes a region where the first opening 12 and the second opening 22 are overlapped with each other.

FIG. 7C illustrates a cross sectional view showing a process of forming the metal post 40. A metal is grown from the terminal 9 to the third opening 32 with an electrolytic plating method. This results in a formation of the metal post 40 in the first opening 12, the second opening 22 and the third opening 32. In this case, the metal post 40 is formed so that the height of the metal post 40 from the piezoelectric substrate 2 to the upper face of the metal post 40 is lower than the height from the piezoelectric substrate 2 to the upper face of the third insulating layer 30.

FIG. 7D illustrates a cross sectional view showing a process of forming the solder ball 50. A ball-shaped solder is placed on the metal post 40 and is subjected to the reflow. This results in a formation of the solder ball 50. With the processes, the surface acoustic wave device in accordance with the first embodiment is manufactured.

FIG. 8A illustrates a top view of the surface acoustic wave device in accordance with the first embodiment. FIG. 8B illustrates a cross sectional view taken along a line A-A1 of FIG. 8A. The surface acoustic wave element 4, the protective layer 6 and the interconnection 8 are not illustrated in FIG. 8B. In accordance with the first embodiment, the third opening 32 includes the region where the first opening 12 and the second opening 22 are overlapped with each other, as illustrated in FIG. 8A and FIG. 8B. As illustrated in FIG. 7C, the metal post 40 is provided in the first opening 12, the second opening 22 and the third opening 32. The third opening 32 determines the shape of the metal post 40. The shape control of the metal post 40 in the plating process is easier than the case of the second comparative embodiment. It is therefore possible to improve the mass productivity.

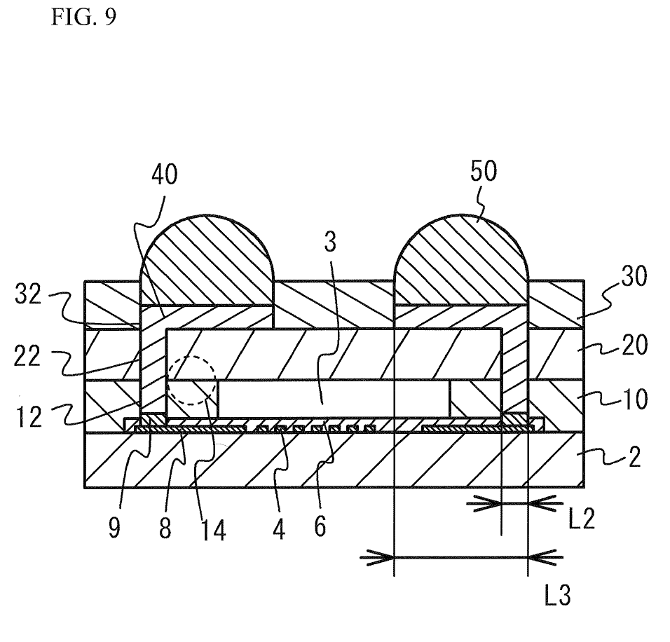

As illustrated in FIG. 6, the cavity 3 is formed with the first insulating layer 10 and the second insulating layer 20. The installation region of the cavity 3 and the surface acoustic wave element 4 does not limit the opening length L3 of the third opening 32. This allows enlargement of the opening length L3 of the third opening 32 with the connection portion 14 between the first insulating layer 10 and the second insulating layer 20 being left. It is therefore possible to form the third opening 32 above the installation region of the cavity 3 and the surface acoustic wave element 4, as illustrated in FIG. 9 showing a variation of the first embodiment. It is therefore possible to keep the diameter of the solder ball 50 large and to secure an installation region of the cavity 3 and the surface acoustic wave element 4. Accordingly, the surface acoustic wave device may be downsized with the solder ball 50 being kept large.

As illustrated in FIG. 8B, a length L5 is larger than a length L4. The length L5 is from the region where the third opening 32 and the second opening 22 are overlapped with each other to one end of the third opening on the cavity 3 side. The length L4 is from the region where the third opening 32 and the second opening 22 are overlapped with each other to the other end of the third opening 32. The opening length L3 is enlarged and the solder ball 50 is enlarged, when the length L5 is enlarged. The surface acoustic wave device is downsized when the length L4 is reduced.

As illustrated in FIG. 6, the height from the piezoelectric substrate 2 to the upper face of the metal post 40 is lower than the height from the piezoelectric substrate 2 to the upper face of the third insulating layer 30. This allows an optional determination of the diameter of the solder ball 50 with the opening length L3. And the solder ball 50 may be formed with the reflow after a ball-shaped solder is provided.

In the first embodiment, the solder ball 50 may be provided with a printing process of the solder on the metal post 40, as in the case of the first comparative embodiment. It is preferable that the ball-shaped solder is provided and is subjected to the reflow, because the process is simplified and the mass productivity is improved.

The first insulating layer 10, the second insulating layer 20 and the third insulating layer 30 are made of photosensitive resin such as epoxy-based negative resist. It is therefore possible to form the above-mentioned insulating layers with photolithography method. This allows an accurate formation of the cavity 3, the first opening 12, the second opening 22 and the third opening 32. The equipment and the process may be simplified. And the mass productivity may be improved.

The metal post 40 can be formed with a single plating process and the mass productivity can be improved, because the third opening 32 includes the first opening 12 and the second opening 22. The metal post 40 may be formed with a non-electrolytic plating method, although the metal post 40 is formed with the electrolytic plating method in the above-mentioned embodiment.

It is only necessary that the first opening 12 be overlapped with at least a part of the terminal 9. It is only necessary that at least a part of the first opening 12 be overlapped with a part of the second opening 22, although the first opening 12 is overlapped with the second opening 22 in the above-mentioned embodiment. It is, however, preferable that the terminal 9, the first opening 12 and the second opening 22 correspond to each other.

In the first embodiment, the surface acoustic wave device includes the surface acoustic wave element 4 on the piezoelectric substrate 2 as an acoustic wave element. However, an acoustic wave device using a film bulk acoustic resonator (FBAR) may be used. A silicon substrate or a glass substrate is used instead of the piezoelectric substrate, if the FBAR is used. In this case, the FBAR is formed on the substrate with a piezoelectric thin film.

The present invention is not limited to the specifically disclosed embodiments, but variations and modifications may be made without departing from the scope of the present invention.

1. An acoustic wave device comprising:
a substrate;
an acoustic wave element provided on the substrate;
a terminal that is provided on the substrate and is electrically coupled to the acoustic wave element;
a first insulating layer that is provided on the substrate and has a first opening at a region thereof overlapped with at least a part of the terminal;
a second insulating layer that has an second opening at a region thereof overlapped with at least a part of the first opening and is provided on the first insulating layer and the acoustic wave element so that a cavity is formed above the acoustic wave element;
a third insulating layer that has a third opening including the region where the first opening and the second opening are overlapped with each other, and is provided on the second insulating layer;
a metal post that is electrically coupled to the terminal and is provided in the first opening, the second opening and the third opening; and
a solder ball provided on the metal post.

2. The acoustic wave device as claimed in claim 1, wherein a length from the region where the third opening and the second opening are overlapped with each other to one end of the third opening on the cavity side is larger than a length from the region where the third opening and the second opening are overlapped with each other to the other end of the third opening.

3. The acoustic wave device as claimed in claim 1, wherein height from the substrate to an upper face of the metal post is lower than that from the substrate to an upper face of the third insulating layer.

4. The acoustic wave device as claimed in claim 1, wherein an opening length of the third opening is larger than a length of the terminal.

5. The acoustic wave device as claimed in claim 1, wherein an opening length of the first opening is equal to that of the second opening.

6. The acoustic wave device as claimed in claim 5, wherein the first opening corresponds to the second opening.

7. The acoustic wave device as claimed in claim 1, wherein the first insulating layer, the second insulating layer and the third insulating layer are made of photosensitive resin.

8. The acoustic wave device as claimed in claim 1, wherein the acoustic wave element is a surface acoustic wave element or a piezoelectric thin film resonator.

9. A method of manufacturing an acoustic wave device comprising:
providing an acoustic wave element on a substrate;
providing a terminal on the substrate so as to be electrically coupled to the acoustic wave element;
providing a first insulating layer on the substrate so that the acoustic wave element is exposed and a first opening of the first insulating layer is overlapped with at least a part of the terminal;
providing a second insulating layer on the substrate and the first insulating layer so that a cavity is formed above the acoustic wave element and a second opening of the second insulating layer is overlapped with at least a part of the first opening;
providing a third insulating layer on the second insulating layer so that a third opening of the third insulating layer includes the region where the first opening and the second opening are overlapped with each other;
providing a metal post in the first opening, the second opening and the third opening so as to be electrically coupled to the terminal; and
providing a solder ball on the metal post.

10. The method as claimed in claim 9, wherein in the step of providing the metal post, the metal post is formed so that height from the substrate to an upper face of the metal post is lower than a height from the substrate to an upper face of the third insulating layer.

11. The method as claimed in claim 9, wherein in the step of providing the metal post, the metal post is formed with a plating method.

12. The method as claimed in claim 9, wherein the cavity, the first opening, the second opening and the third opening are formed with photolithography method.

13. The method as claimed in claim 9, wherein in the step of providing the acoustic wave element, a surface acoustic wave element or a piezoelectric thin film resonator is provided.
